(19) United States
(12) Patent Application Publication
(10) Pub. No.: US 2022/0168976 A1
(43) Pub. Date: Jun. 2, 2022

(54) GLASS FIBER TAPE, AND SURFACE MODIFICATION METHOD AND APPLICATION THEREOF

(71) Applicants: HEFEI INSTITUTES OF PHYSICAL SCIENCE,CHINESE ACADEMY OF SCIENCES, Hefei (CN); HEFEI JUNENG ELECTRO PHYSICS HIGH-TECH DEVELOPMENT CO., LTD., Hefei (CN)

(72) Inventors: Zhihong LIU, Hefei (CN); Jing SUN, Hefei (CN); Wenge CHEN, Hefei (CN)

(21) Appl. No.: 17/674,426

(22) Filed: Feb. 17, 2022

Related U.S. Application Data
(63) Continuation of application No. PCT/CN2021/140828, filed on Dec. 23, 2021.

(30) Foreign Application Priority Data
Nov. 23, 2021 (CN) 202111416985.2

(51) Int. Cl. B29C 70/54; C03C 13/00; B29C 71/00; C03C 25/1095

(52) U.S. Cl. CPC B29C 70/54; C03C 13/00; C03C 2213/00; C03C 25/1095; B29C 71/0009

(57) ABSTRACT

Disclosed are a glass fiber tape, a surface modification method and an application thereof. The surface modification method includes the determination of an optimal decarburizing condition of the glass fiber tape, the decarburization of the glass fiber tape, and the coating of palmitic acid.

### CROSS-REFERENCE TO RELATED APPLICATIONS

This application is a continuation of International Patent Application PCT/CN2021/140828, filed on Dec. 23, 2021, which claims the benefit of priority from Chinese patent application No. 202111416985.2, filed on Nov. 23, 2021. The content of the aforementioned application, including any intervening amendments thereto, is incorporated herein by reference in its entirety.

### TECHNICAL FIELD

The present application relates to fiber surface modification, and more particularly to a glass fiber tape, and a surface modification method and an application thereof.

### BACKGROUND

The glass fiber is primarily composed of SiO₂, Al₂O₃, MgO, B₂O₃ and CaO, which has excellent mechanical properties, electrical insulation properties and chemical stability. In addition, the glass fiber is corrosion-resistant, high-temperature-resistant, non-combustible, and low-cost, and has been widely used in functional materials, e.g., reinforcement materials, filter materials, electrical insulation materials, heat insulation materials, sound absorption materials, and shock absorption materials.

A glass fiber-resin composite material is commonly used in an insulation structure of the superconducting magnet. The superconducting magnet is made of the type II superconductor that has a high transition temperature and a particularly high critical magnetic field. It is free of electrical loss induced by wire resistance and magnetic loss induced by an iron core, and has a promising practical application prospect. The superconducting magnet has been extensively used in industry and scientific research, but it struggles with a harsh operation condition (at a liquid-helium temperature) and thus brings high cost. The insulation structure of the superconducting magnet is required to not only bear the mechanical load at high field, but also meet the requirements of high-strength electrical insulation performance and irradiation resistance. Given that the glass fiber mainly plays a load-bearing role in the insulation structure, it has a great impact on the strength, stiffness and insulating properties of the whole insulation structure.

To reach the superconducting phase, the magnet tends is often treated by high temperature. Then, the sizing agent on the surface of the glass fiber tape is volatilized and carbonized at the high temperature via a winding and reacting process, resulting in a significantly decreased insulation performance of the glass fiber tape-resin composite material. Therefore, a surface modification method of the glass fiber tape is developed herein to overcome the above technical problems.

### SUMMARY

An object of this disclosure is to provide a glass fiber tape, and a surface modification method and an application thereof to overcome the above-mentioned deficiencies in the prior art.

Technical solutions of this disclosure are described as follows.

In a first aspect, this application provides a surface modification method of a glass fiber tape, comprising:

(S1) detecting an initial surface carbon content C₀ of the glass fiber tape; selecting heating temperature and heating time as factors of decarburization; designing five levels for the heating temperature, respectively 400° C., 450° C., 500° C., 550° C. and 600° C., and designing three levels for the heating time, respectively 2 h, 3 h and 4 h; designing an orthogonal test based on the five levels for the heating temperature and the three levels for the heating time; subjecting the glass fiber tape to decarburization under different combinations of the heating temperature and the heating time; and after the decarburization, detecting a residual surface carbon content C₁ of the glass fiber tape, and calculating a surface carbon content decline rate N of the glass fiber tape according to the following formula:

N(%)=(C₀−C₁)/C₀×100%;

wherein an optimal decarburizing condition is determined when the surface carbon content decline rate N is more than 70%;

(S2) subjecting the glass fiber tape to decarburization under the optimal decarburizing condition determined in step (S1); and

(S3) immersing a decarburized glass fiber tape in a palmitic acid solution for 1-3 h followed by drying.

In the surface modification method provided herein, the glass fiber tape is subjected to air-heating treatment to remove the sizing agent left on the surface of the glass fiber tape, lower the surface carbon content, and enhance the insulation performance of the glass fiber tape-resin composite material. The coating of the palmitic acid can protect the decarburized glass fiber tape and enhance the mechanical property to facilitate the subsequent use.

In an embodiment, after the decarburization in step (S2), an actual residual surface carbon content C₂ of the glass fiber tape is detected; if an actual surface carbon content decline rate N′ of the glass fiber tape is more than 70%, step (S3) is performed, otherwise, the decarburization in step (S2) is performed until the actual surface carbon content decline rate N′ of the glass fiber tape is more than 70%;

wherein the actual surface carbon content decline rate N′ is calculated through the following formula:

N′(%)=(C₀−C₂)/C₀×100%.

After the decarburization, the residual surface carbon content of the glass fiber tape is detected, and the surface carbon content decline rate is considered as an index to evaluate whether the decarburization treatment is satisfied, which can greatly increase the qualified rate of products and improving the product quality.

In an embodiment, the palmitic acid solution in step (S3) is a mixture of palmitic acid and ethanol, and a mass ratio of the palmitic acid to the ethanol is 5-10:100, preferably 8:100.

It has been found that after immersed in the palmitic acid solution prepared according to this compounding ratio, the mechanical properties of the decarburized glass fiber tape can be greatly enhanced.

In an embodiment, in step (S3), the decarburized glass fiber tape is immersed in the palmitic acid solution at room temperature for 1-3 h, and then vertically dried in air.

In a second aspect, this disclosure provides a glass fiber tape prepared by the above surface modification method. In the practical application, the glass fiber tape is subjected to quantitative cutting, completely dispersed and then transferred to a muffle furnace to undergo an air-heating treatment. After the heating temperature and time meet the decarburization requirements, the glass fiber tape is cooled to room temperature, and then immersed in a 8% palmitic acid solution and vertically dried for use.

In a third aspect, this disclosure provides an application of the glass fiber tape in an insulation structure of a superconducting magnet.

Compared to the prior art, this disclosure has the following beneficial effects.

The surface modification method provided herein includes the decarburization of the glass fiber tape and the coating of the palmitic acid. Through the air-heating treatment, the sizing agent on the surface of the glass fiber tape can be removed, and the surface carbon content of the glass fiber tape can be reduced, enhancing the insulation performance of the glass fiber tape-resin composite material. Through the coating of the palmitic acid, the decarburized glass fiber tape can be protected to allow for enhanced mechanical property for subsequent uses. The modified glass fiber tape prepared by the surface modification method can be used in an insulation structure of a superconducting magnet to improve the intensity and stiffness of the insulation structure without influencing the insulation performance.

### BRIEF DESCRIPTION OF THE DRAWINGS

FIG. 1 is a flow chart of a surface modification method of a glass fiber tape according to an embodiment of the disclosure;

FIG. 2 is a thermogravimetry (TG) diagram of the glass fiber tape before and after decarburization according to an embodiment of the disclosure; and

FIG. 3 is a differential scanning calorimetry (DSC) diagram of the glass fiber tape before and after the decarburization according to an embodiment of the disclosure;

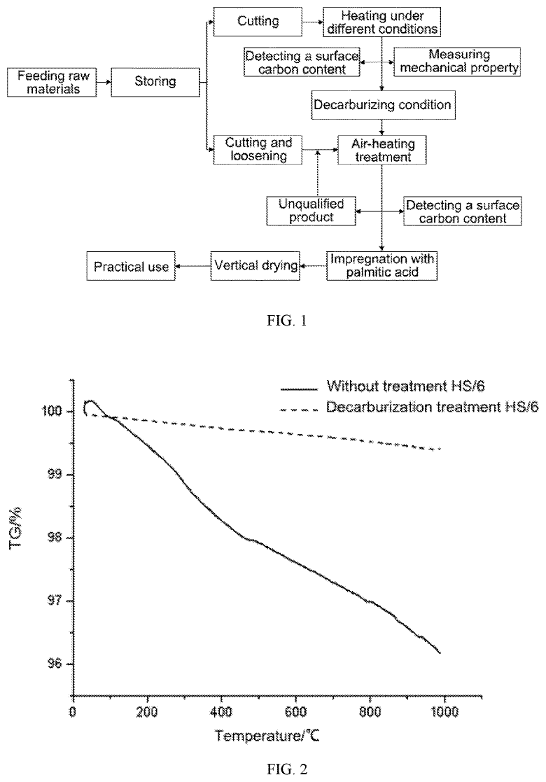

### DETAILED DESCRIPTION OF EMBODIMENTS

To render the objects, technical solutions, and advantages of the present disclosure clearer, the disclosure will be described in detail below with reference to the embodiments.

### EXAMPLE 1

Provided was a surface modification method of a glass fiber tape, including a surface decarburization process and a palmitic acid coating process, which was specifically performed as follows.

(S1) Determining an Optimal Decarburizing Condition of the Glass Fiber Tape

An appropriate amount of the HS/6 glass fiber tape was cut and subjected to air-heating treatment (heating and cooling with the furnace) at 400° C., 450° C., 500° C., 550° C. and 600° C. for 2 h, 3 h and 4 h, respectively. After that, a surface carbon content of the HS/6 glass fiber tape treated under different conditions was detected, and the thermal treatment condition corresponding to a surface carbon content decline rate of 70% or more was considered qualified. Combining with the mechanical properties (the strength retention reached 20% or more), the optimal decarburizing condition was considered to be 500° C. for 4 h.

(S2) Decarburization

A certain amount of the HS/6 glass fiber tape was completely loosened to avoid affecting the volatilization and reaction of the sizing agent, and then transferred to a muffle furnace to undergo the decarburization treatment under the optimal condition determined in step (S1). The decarburized HS/6 glass fiber tape was sampled to detect the surface carbon content, where those with a surface carbon content decline rate of 70% or more were considered qualified, and the unqualified products needed to be re-decarburized.

(S3) Coating of Palmitic Acid

120 g of palmitic acid was added to 1500 g of ethanol to obtain a mixture, which was heated to 38° C. using a heating plate and stirred with a magnetic stirring device to obtain a palmitic acid solution. Then the decarburized HS/6 glass fiber tape was immersed in the palmitic acid solution at room temperature for 2 h, and vertically dried in air.

TABLE 1
Surface element content of the HS/6 glass fiber tape before and after
decarburization

| | Surface element content (%) | | | | |
|---|---|---|---|---|---|
| | C | O | Si | Al | Mg |
| Before decarburization | 67.61 | 25.52 | 4.34 | 1.73 | 0.8 |
| After decarburization | 15.32 | 51.82 | 20.17 | 7.79 | 4.9 |

As shown in Table 1, the initial surface carbon content of the HS/6 glass fiber tape was 67.61%, while after decarburization, the surface carbon content of the HS/6 glass fiber tape was 15.32%, namely, a surface carbon content decline rate of 77.34%, indicating that through the decarburization, the content of the sizing agent on the surface of the HS/6 glass fiber tape could be reduced to a reasonable range.

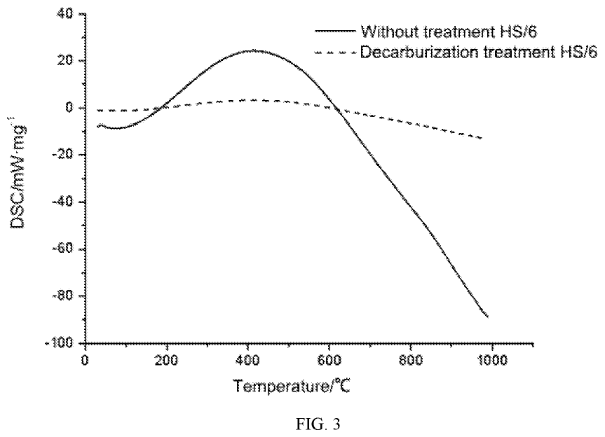

It could be seen from FIG. 2 and FIG. 3 that after the decarburization, the thermal weight loss of the HS/6 glass fiber tape was lower, and there were no obvious endothermic/exothermic peaks, indicating that most of the sizing agent on the surface of the HS/6 glass fiber tape was removed.

### EXAMPLE 2

Provided was a surface modification method of a glass fiber tape, including a surface decarburization process and a palmitic acid coating process. The surface modification method provided herein was different from that in Example 1 that in Example 2, after the decarburization, the detection of the actual residual surface carbon content of the HS/6 glass fiber tape was omitted. The surface modification method provided herein was specifically performed as follows.

(S1) Determining an Optimal Decarburizing Condition of the Glass Fiber Tape

An appropriate amount of the HS/6 glass fiber tape was cut and subjected to air-heating treatment (heating and cooling with the furnace) at 400° C., 450° C., 500° C., 550° C. and 600° C. for 2 h, 3 h and 4 h, respectively. After that, a surface carbon content of the HS/6 glass fiber tape treated under different conditions was detected, and the thermal treatment condition corresponding to a surface carbon content decline rate of 70% or more was considered qualified. Combining with the mechanical properties, to obtain the optimal decarburizing condition.

(S2) Decarburization

A certain amount of the HS/6 glass fiber tape was completely loosened to avoid affecting the volatilization and reaction of the sizing agent, and then transferred to a muffle furnace to undergo the decarburization treatment under the optimal condition determined in step (S1).

(S3) Coating of Palmitic Acid

120 g of palmitic acid was added to 1500 g of ethanol to obtain a mixture, which was heated to 38° C. using a heating plate and stirred with a magnetic stirring device to obtain a palmitic acid solution. Then the decarburized HS/6 glass fiber tape was immersed in the palmitic acid solution at room temperature for 2 h, and vertically dried in air.

### EXAMPLE 3

Provided was a surface modification method of a glass fiber tape, including a surface decarburization process and a palmitic acid coating process. The surface modification method provided herein was different from that in Example 1 that in Example 3, a mass ratio of the palmitic acid to the ethanol was 5:100. The surface modification method provided herein was specifically performed as follows.

(S1) Determining an Optimal Decarburizing Condition of the Glass Fiber Tape

An appropriate amount of the HS/6 glass fiber tape was cut and subjected to air-heating treatment (heating and cooling with the furnace) at 400° C., 450° C., 500° C., 550° C. and 600° C. for 2 h, 3 h and 4 h, respectively. After that, a surface carbon content of the HS/6 glass fiber tape treated under different conditions was detected, and the thermal treatment condition corresponding to a surface carbon content decline rate of 70% or more was considered qualified. Combining with the mechanical properties, to obtain the optimal decarburizing condition.

(S2) Decarburization

A certain amount of the HS/6 glass fiber tape was completely loosened to avoid affecting the volatilization and reaction of the sizing agent, and then transferred to a muffle furnace to undergo the decarburization treatment under the optimal condition determined in step (S1). The decarburized HS/6 glass fiber tape was sampled to detect the surface carbon content, where those with a surface carbon content decline rate of 70% or more were considered qualified, and the unqualified products needed to be re-decarburized.

(S3) Coating of Palmitic Acid

75 g of palmitic acid was added to 1500 g of ethanol to obtain a mixture, which was heated heated to 38° C. using a heating plate and stirred with a magnetic stirring device to obtain a palmitic acid solution. Then the decarburized HS/6 glass fiber tape was immersed in the palmitic acid solution at room temperature for 2 h, and vertically dried in air.

### EXAMPLE 4

Provided was a surface modification method of a glass fiber tape, including a surface decarburization process and a palmitic acid coating process. The surface modification method provided herein was different from that in Example 1 that in Example 4, a mass ratio of the palmitic acid to the ethanol was 10:100. The surface modification method provided herein was specifically performed as follows.

(S1) Determining an Optimal Decarburizing Condition of the Glass Fiber Tape

An appropriate amount of the HS/6 glass fiber tape was cut and subjected to air-heating treatment (heating and cooling with the furnace) at 400° C., 450° C., 500° C., 550° C. and 600° C. for 2 h, 3 h and 4 h, respectively. After that, a surface carbon content of the HS/6 glass fiber tape treated under different conditions was detected, and the thermal treatment condition corresponding to a surface carbon content decline rate of 70% or more was considered qualified. Combining with the mechanical properties, to obtain the optimal decarburizing condition.

(S2) Decarburization

A certain amount of the HS/6 glass fiber tape was completely loosened to avoid affecting the volatilization and reaction of the sizing agent, and then transferred to a muffle furnace to undergo the decarburization treatment under the optimal condition determined in step (S1). The decarburized HS/6 glass fiber tape was sampled to detect the surface carbon content, where those with a surface carbon content decline rate of 70% or more were considered qualified, and the unqualified products needed to be re-decarburized.

(S3) Coating of Palmitic Acid

150 g of palmitic acid was added to 1500 g of ethanol to obtain a mixture, which was heated to 38° C. using a heating plate and stirred with a magnetic stirring device to obtain a palmitic acid solution. Then the decarburized HS/6 glass fiber tape was immersed in the palmitic acid solution at room temperature for 2 h, and vertically dried in air.

### Comparative Example 1

Provided was a surface modification method of a glass fiber tape. The surface modification method provided herein was different from that in Example 1 that in Comparative Example 1, the determination of an optical decarburizing condition and the decarburization of the HS/6 glass fiber tape were omitted. The surface modification method provided herein was described in detail below.

(S1) Coating of Palmitic Acid

120 g of palmitic acid was added to 1500 g of ethanol to obtain a mixture, which was heated to 38° C. using a heating plate and stirred with a magnetic stirring device to obtain a palmitic acid solution. Then the decarburized HS/6 glass fiber tape was immersed in the palmitic acid solution at room temperature for 2 h, and vertically dried in air.

### Comparative Example 2

Provided was a surface modification method of a glass fiber tape. The surface modification method provided herein was different from that in Example 1 that in Comparative Example 2, the coating of palmitic acid was omitted. The surface modification method provided herein was described in detail below.

(S1) Determining an Optimal Decarburizing Condition of the Glass Fiber Tape

An appropriate amount of the HS/6 glass fiber tape was cut and subjected to air-heating treatment (heating and cooling with the furnace) at 400° C., 450° C., 500° C., 550° C. and 600° C. for 2 h, 3 h and 4 h, respectively. After that, a surface carbon content of the HS/6 glass fiber tape treated under different conditions was detected, and the thermal treatment condition corresponding to a surface carbon content decline rate of 70% or more was considered qualified. Combining with the mechanical properties, to obtain the optimal decarburizing condition.

(S2) Decarburization

A certain amount of the HS/6 glass fiber tape was completely loosened to avoid affecting the volatilization and reaction of the sizing agent, and then transferred to a muffle furnace to undergo the decarburization treatment under the optimal condition determined in step (S1). The decarburized HS/6 glass fiber tape was sampled to detect the surface carbon content, where those with a surface carbon content decline rate of 70% or more were considered qualified, and the unqualified products needed to be re-decarburized.

### Comparative Example 3

Provided was a surface modification method of a glass fiber tape, including a surface decarburization process and a palmitic acid coating process. The surface modification method provided herein was different from that in Example 1 that in Comparative Example 3, a mass ratio of the palmitic acid to the ethanol was 2:100. The surface modification method provided herein was specifically performed as follows.

(S1) Determining an Optimal Decarburizing Condition of the Glass Fiber Tape

An appropriate amount of the HS/6 glass fiber tape was cut and subjected to air-heating treatment (heating and cooling with the furnace) at 400° C., 450° C., 500° C., 550° C. and 600° C. for 2 h, 3 h and 4 h, respectively. After that, a surface carbon content of the HS/6 glass fiber tape treated under different conditions was detected, and the thermal treatment condition corresponding to a surface carbon content decline rate of 70% or more was considered qualified. Combining with the mechanical properties, to obtain the optimal decarburizing condition.

(S2) Decarburization

A certain amount of the HS/6 glass fiber tape was completely loosened to avoid affecting the volatilization and reaction of the sizing agent, and then transferred to a muffle furnace to undergo the decarburization treatment under the optimal condition determined in step (S1). The decarburized HS/6 glass fiber tape was sampled to detect the surface carbon content, where those with a surface carbon content decline rate of 70% or more were considered qualified, and the unqualified products needed to be re-decarburized.

(S3) Coating of Palmitic Acid

30 g of palmitic acid was added to 1500 g of ethanol to obtain a mixture, which was heated to 38° C. using a heating plate and stirred with a magnetic stirring device to obtain a palmitic acid solution. Then the decarburized HS/6 glass fiber tape was immersed in the palmitic acid solution at room temperature for 2 h, and vertically dried in air.

### Comparative Example 4

Provided was a surface modification method of a glass fiber tape, including a surface decarburization process and a palmitic acid coating process. The surface modification method provided herein was different from that in Example 1 that in Comparative Example 4, a mass ratio of the palmitic acid to the ethanol was 12:100. The surface modification method provided herein was specifically performed as follows.

(S1) Determining an Optimal Decarburizing Condition of the Glass Fiber Tape

An appropriate amount of the HS/6 glass fiber tape was cut and subjected to air-heating treatment (heating and cooling with the furnace) at 400° C., 450° C., 500° C., 550° C. and 600° C. for 2 h, 3 h and 4 h, respectively. After that, a surface carbon content of the HS/6 glass fiber tape treated under different conditions was detected, and the thermal treatment condition corresponding to a surface carbon content decline rate of 70% or more was considered qualified. Combining with the mechanical properties, to obtain the optimal decarburizing condition.

(S2) Decarburization

A certain amount of the HS/6 glass fiber tape was completely loosened to avoid affecting the volatilization and reaction of the sizing agent, and then transferred to a muffle furnace to undergo the decarburization treatment under the optimal condition determined in step (S1). The decarburized HS/6 glass fiber tape was sampled to detect the surface carbon content, where those with a surface carbon content decline rate of 70% or more were considered qualified, and the unqualified products needed to be re-decarburized.

(S3) Coating of Palmitic Acid

180 g of palmitic acid was added to 1500 g of ethanol to obtain a mixture, which was heated to 38° C. using a heating plate and stirred with a magnetic stirring device to obtain a palmitic acid solution. Then the decarburized HS/6 glass fiber tape was immersed in the palmitic acid solution at room temperature for 2 h, and vertically dried in air.

### Experimental Example 1

The HS/6 glass fiber tapes prepared in Examples 1-4 and Comparative Examples 1-4 were subjected to a mechanical testing (referring to GB/T7689.5). The testing results were shown in Table. 2.

TABLE 2
Mechanical testing results of the HS/6 glass fiber tapes

| | Mechanical property (N/25 mm) |
|---|---|
| Example 1 | 516.8 |
| Example 2 | 519 |
| Example 3 | 498.6 |
| Example 4 | 521.8 |
| Comparative | 1981.2 |
| Example 1 | |
| Comparative | 421.2 |
| Example 2 | |
| Comparative | 450.6 |
| Example 3 | |
| Comparative | 484.2 |
| Example 4 | |

It could be seen from Table 2 that the strength of the HS/6 glass fiber tape decreased after the decarburization owing to the absence of sizing agent. After the modification of the palmitic acid, the strength of the HS/6 glass fiber tape was enhanced.

### Experimental Example 2

The HS/6 glass fiber tapes prepared in Example 1, and Comparative Examples 1-2 were selected to manufacture a glass fiber tape-resin composite material, which was specifically described below.

(S1) A resin system was prepared from 60 parts by weight of bisphenol-F diglycidyl ether (GY 282), 40 parts by weight of a curing agent (diethyltoluenediamine), and 21 parts by weight of a diluting agent (polypropylene glycol diglycidyl ether).

(S2) The glass fiber tape was enveloped around a 304 stainless steel panel in a half-lapping form to undergoes a vacuum-heat treatment at 640° C. for 4 h.

(S3) The glass fiber tape was impregnated into the resin system under vacuum pressure, followed by glue injection, curing, and demoulding to obtain the glass fiber tape-resin composite material.

The insulation strength and mechanical property of the glass fiber tape-resin composite material were tested, and the test results were shown in Table 3. A comparison between the Example 1 and the Comparative Example 1 indicated that through the decarburization, the insulation strength of the glass fiber tape-resin composite material was enhanced, while the mechanical property of the glass fiber tape-resin composite material was lowered. A comparison between the Example 1 and the Comparative Example 2 indicated that through the modification by the palmitic acid, the mechanical property of the glass fiber tape-resin composite material was enhanced.

TABLE 3
Insulation strength and mechanical property comparison of the
glass fiber tape-resin composite materials

| | Insulation strength | Mechanical property |
|---|---|---|
| | (breakdown voltage) | (0° tensile MPa) |
| Example 1 | Failed to breakdown at 100 kV | 272 |
| Comparative | 60 | 403 |
| Example 1 | | |
| Comparative | Failed to breakdown at 100 kV | 245 |
| Example 2 | | |

It should be noted that the above embodiments are only used to illustrate the technical solutions of the present application, and not intended to limit the scope of the present application. Although the present application has been described in detail above, it should be understood that any modifications, replacements and improvements made by those skilled in the art without departing from the scope of the present application shall fall within the scope of the present application defined by the appended claims.

What is claimed is:

1. A surface modification method of a glass fiber tape, comprising:
(S1) detecting an initial surface carbon content C₀ of the glass fiber tape;
selecting heating temperature and heating time as factors of decarburization;
designing five levels for the heating temperature, respectively 400° C., 450° C., 500° C., 550° C. and 600° C., and designing three levels for the heating time, respectively 2 h, 3 h and 4 h; designing an orthogonal test based on the five levels for the heating temperature and the three levels for the heating time; subjecting the glass fiber tape to decarburization under different combinations of the heating temperature and the heating time; and after the decarburization, detecting a residual surface carbon content C₁ of the glass fiber tape, and calculating a surface carbon content decline rate N of the glass fiber tape according to the following formula:
N(%)=(C₀−C₁)/C₀×100%;
wherein an optimal decarburizing condition is determined when the surface carbon content decline rate N is more than 70%;
(S2) subjecting the glass fiber tape to decarburization under the optimal decarburizing condition determined in step (S1); and
(S3) immersing a decarburized glass fiber tape in a palmitic acid solution for 1-3 h, followed by drying.

2. The surface modification method of claim 1, further comprising:
after decarburization in step (S2), detecting an actual residual surface carbon content C2 of the glass fiber tape; if an actual surface carbon content decline rate N′ of the glass fiber tape is more than 70%, performing step (S3), otherwise, performing step (S2) until the actual surface carbon content decline rate N′ of the glass fiber tape is more than 70%;
wherein the actual surface carbon content decline rate N′ is calculated through the following formula:
N′(%)=(C₀−C₂)/C₀×100%.

3. The surface modification method of claim 1, wherein the palmitic acid solution in step (S3) is a mixture of palmitic acid and ethanol, and a mass ratio of the palmitic acid to the ethanol is 5-10:100.

4. The surface modification method of claim 3, wherein a mass ratio of the palmitic acid to the ethanol is 8:100.

5. The surface modification method of claim 1, wherein in step (S3), the decarburized glass fiber tape is immersed in the palmitic acid solution at room temperature for 1-3 h, and then vertically dried in air.

6. A glass fiber tape, wherein the glass fiber tape is prepared by the surface modification method of claim 1.

7. An insulation structure for a superconducting magnet, wherein the insulation structure is made of the glass fiber tape of claim 6.
